(19) United States
(12) Patent Application Publication
(10) Pub. No.: US 2026/0285219 A1
(43) Pub. Date: Sep. 24, 2026

(54) VEHICULAR VISION SYSTEM WITH HEADLAMP SAFETY CONTROL

(71) Applicant: Magna Electronics Inc., Auburn Hills, MI (US)

(72) Inventor: Bishnu Raveendran, Rochester, MI (US)

(21) Appl. No.: 19/569,129

(22) Filed: Mar. 17, 2026

Related U.S. Application Data
(60) Provisional application No. 63/774,941, filed on Mar. 20, 2025.

(51) Int. Cl. B60Q 1/08; B60Q 1/14; G06V 20/58; G06V 40/10

(52) U.S. Cl. CPC B60Q 1/085; B60Q 1/1423; G06V 20/58; G06V 40/103; B60Q 2300/056; B60Q 2300/116; G06V 2201/07

(57) ABSTRACT

A sensing system includes a camera disposed at a vehicle that views exterior of the vehicle and at least forward of the vehicle. The system, at least in part via processing at an electronic control unit (ECU) of image data captured by the camera, (i) detects an object that is present exterior of the vehicle and at or near a field of illumination of a headlamp of the vehicle and (ii) determines that the object includes a vulnerable object that should not be present in the field of illumination of the headlamp of the vehicle when the headlamp is electrically operated to emit light. With the vehicle parked, and responsive to determination of the vulnerable object present exterior of the vehicle and at or near the field of illumination, the system controls operation of the headlamp to limit the headlamp from electrically operating to emit light.

### CROSS REFERENCE TO RELATED APPLICATION

The present application claims the filing benefits of U.S. provisional application Ser. No. 63/774,941, filed Mar. 20, 2025, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A driving assistance system or vision system or imaging system for a vehicle utilizes one or more cameras (preferably one or more CMOS cameras) to capture image data representative of images exterior of the vehicle, and processes the captured image data to detect presence of object exterior of the vehicle and in a region at least forward of the vehicle. Based on determination that the detected object is a vulnerable object that could be harmed by illumination from headlamps of the vehicle, the system limits operation of the headlamps.

For example, a sensing system includes a camera disposed at a vehicle equipped with the vehicular sensing system, where the camera views exterior of the vehicle and at least forward of the vehicle. The camera includes an imager, and the imager includes a CMOS imaging array having at least one million photosensors arranged in rows and columns. An electronic control unit (ECU) includes electronic circuitry and associated software. The electronic circuitry of the ECU includes an image processor for processing image data captured by the camera and transferred to the ECU. The vehicular sensing system, at least in part via processing at the ECU of image data captured by the camera and transferred to the ECU, (i) detects an object that is present exterior of the vehicle and at or near a field of illumination of a headlamp of the vehicle and (ii) determines that the object comprises a vulnerable object that should not be present in the field of illumination of the headlamp of the vehicle when the headlamp is electrically operated to emit light. With the vehicle parked, and responsive to determination of the vulnerable object present exterior of the vehicle and at or near the field of illumination of the headlamp of the vehicle, the vehicular sensing system controls operation of the headlamp of the vehicle to limit the headlamp from electrically operating to emit light.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a sensing system that incorporates cameras; and

FIG. 2 is a schematic diagram of the sensing system that processes sensor data from cameras and sensors disposed at the vehicle for detecting presence of vulnerable objects in a field of illumination of a headlamp of the vehicle.

### DESCRIPTION OF THE PREFERRED EMBODIMENTS

A risk is posed by high-intensity vehicular headlamps shining light directly into the eyes of individuals, and particularly small children, when a vehicle is turned on. For example, a vehicle may be started while a child is in front of a vehicle and dark conditions may cause an automatic headlamp system of the vehicle to activate the headlamps. Especially in a confined environment like a garage, the sudden brightness and intense light from the headlamps can be harmful to human vision. This may cause discomfort and even lead to temporary or permanent vision problems.

A vehicle vision system and/or driver or driving assist system and/or object detection system and/or alert system operates to capture images and/or sensor data exterior of the vehicle and may process the captured image data and/or sensor data to display images and/or to detect objects at or near the vehicle and in the predicted path of the vehicle, such as to assist a driver of the vehicle in maneuvering the vehicle in a rearward direction during a parking maneuver. The vision system includes a data processor for processing captured sensor data and an image processor or image processing system that is operable to receive image data from one or more cameras and provide an output to a display device for displaying images representative of the captured image data. Optionally, the vision system may provide display, such as a rearview display or a top down or bird's eye or surround view display or the like.

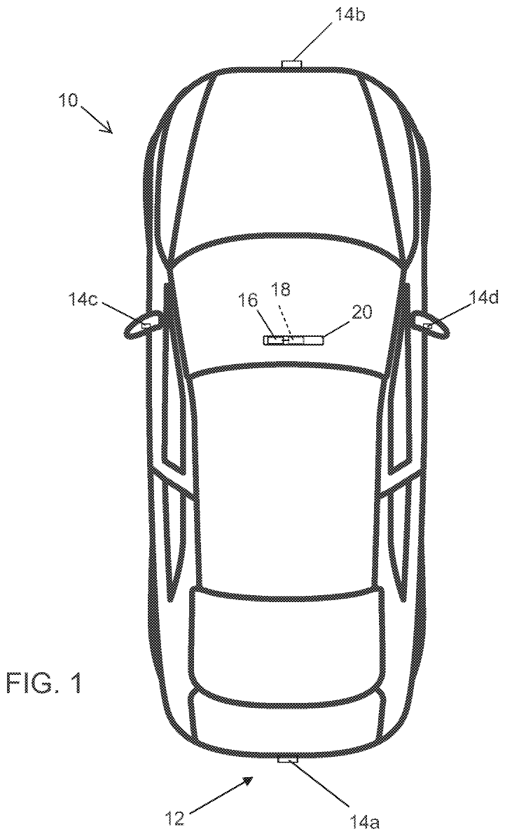

Referring now to the drawings and the illustrative embodiments depicted therein, a vehicle 10 includes an imaging system or vision system 12 that includes at least one exterior viewing imaging sensor or camera, such as a rear backup camera or rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

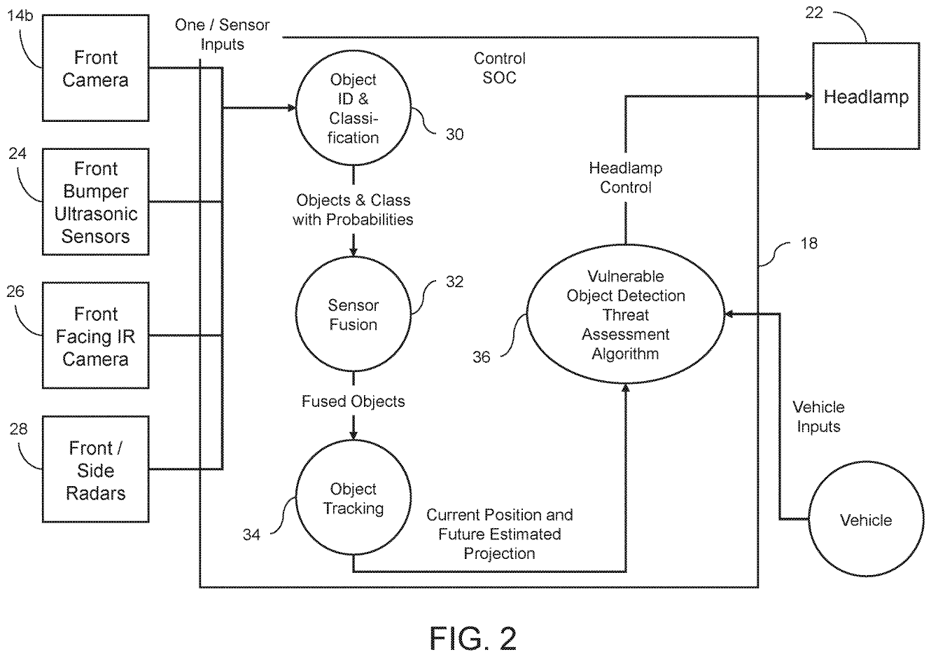

To prevent or reduce the chance of a headlamp 22 of the vehicle 10 being operated to emit light when a vulnerable object, such as a person or animal and especially a child or pet like a dog or cat, is in front of the vehicle 10 and could be harmed by illumination from the headlamp 22, the vehicular vision system 12 monitors for presence of vulnerable objects in front of the vehicle 10 before activating or operating the headlamp 22 (FIG. 2). That is, the vehicular vision system 12 uses forward facing sensors to detect if a person, especially a child, or pet is in front of the vehicle 10.

Referring to FIG. 2, the vehicular vision system 12 receives image data captured by the forward viewing camera 14b of the vehicle 10, which may include a forward viewing windshield mounted camera disposed at a cabin facing surface of the windshield and viewing through the windshield to capture image data representative of the region exterior and at least forward of the vehicle 10. Typically used for advanced driving assistance systems (ADAS), the forward viewing camera 14b may provide visual input to the system 12 for detecting objects in front of the vehicle 10. Optionally, the vehicular vision system 12 may receive image data captured by a bumper mounted camera disposed at and/or behind a portion of a front bumper or grille or front fascia of the vehicle 10 and viewing at least forward of the vehicle 10. The bumper mounted camera may provide a low angle view for detecting smaller objects, such as children, in front of the vehicle 10.

Moreover, the vehicular vision system 12 may receive sensor data captured by one or more ultrasonic sensors 24 disposed at a forward portion of the vehicle 10, such as at and/or behind a portion of the front bumper or grille or front fascia of the vehicle, and sensing respective regions exterior and at least forward of the vehicle 10. The ultrasonic sensors 24 may detect objects and measure distance between the vehicle 10 and detected objects using ultrasonic waves, thus providing additional data points for the vision system 12. In other words, processing sensor data captured by the ultrasonic sensors 24 may provide another data set from which the vision system 12 may detect objects and it may allow the vision system 12 to determine distance between the vehicle 10 and the detected object.

In some examples, the vehicle 10 may include one or more infrared (IR) or near infrared (NIR) cameras 26 that view exterior and at least forward of the vehicle 10 and that capture sensor data based on IR light or NIR light incident at the camera 26. The vision system 12 may process sensor data captured by the NIR camera 26 to detect heat signatures, which may allow the vision system 12 to more easily detect living beings in low light conditions.

Further, the system 12 may receive sensor data from one or more radar sensors 28 at the vehicle 10. The radar sensors 28 may be disposed at forward portions of the vehicle 10, such as at or behind the front bumper or grille or front fascia of the vehicle 10, and/or at side portions of the vehicle 10, such as at or behind body panels or wheel wells of the vehicle 10, and sense respective regions exterior of the vehicle 10. Sensor data captured by the radar sensors 28 may be processed by the vision system 12 to detect the presence and movement of objects at or near the vehicle 10, which may enhance the accuracy of object detection in the region forward of the vehicle 10.

The ECU 18 of the vehicular vision system 12 may operate as a system on chip (SOC) that receives the sensor data from the one or more sensors at the vehicle 10.

Based on processing the captured sensor data, the vision system 12 may identify and/or classify detected objects in the region forward of the vehicle 10. That is, the vision system 12 may operate an object identification and classification algorithm 30 that analyzes the data to recognize various objects around the vehicle 10. For example, the vision system 12 may identify inanimate objects, people and/or animals near the vehicle 10. Optionally, the system 12 may distinguish between adult humans and children, and/or between pets (e.g., dogs and cats) and other animals (e.g., deer, farm animals like cows and horses, and the like).

When the vision system 12 receives sensor data from a plurality of different sensors, a sensor fusion algorithm or technique 32 may combine the data from the different sources. For example, ultrasonic sensor data or radar sensor data may be processed to detect presence of objects in front of the vehicle and image data captured by the forward viewing camera and/or image data captured by the NIR camera may be processed to determine classifications of objects in front of the vehicle. The sensor fusion algorithm 32 may fuse these determinations to match detected objects with their determined classifications. This may increase the confidence and accuracy of the identified objects.

With objects near the vehicle 10 detected and/or identified, the vision system 12 may track position of the detected objects relative to the vehicle 10. In other words, the vision system 12 may operate an object tracking algorithm 34 to monitor movement of the detected objects and ensure continuous awareness of their position relative to the vehicle 10. A future position of the detected object may be estimated or predicted, such as based on the current position and movement velocity of the detected object. The current position, classification, and predicted future position of the detected objects may be provided to a vulnerable object detection algorithm 36. Optionally, the object tracking algorithm 34 may only track detected objects having a subset of classifications, such as to continue tracking detected objects that classify as vulnerable (e.g., humans, animals, other vehicles, bicycle riders and the like) while ceasing tracking detected objects that do not classify as vulnerable (e.g., objects like plants and debris).

Thus, based on the processing of captured sensor data, the vision system 12 operates the vulnerable object detection algorithm 36 to determine whether a vulnerable object is present at or near the front of the vehicle 10. For example, the system 12 may determine the presence of a vulnerable object based on detection of a living object (e.g., a person or child or animal or pet) at or near the front of the vehicle 10. The system 12 may determine the presence of the vulnerable object based on determination that the object is present at or near a field of illumination of the headlamp 22 and/or based on a predicted future position of the object being at or near the field of illumination of the headlamp 22.

That is, the vulnerable object detection algorithm 36 may detect vulnerable objects of interest. The algorithm 36 may distinguish between living beings and inanimate objects. The vulnerable object detection algorithm 36 may focus on identifying objects directly in front of the vehicle 10, such as to ensure that detection is relevant and timely. Optionally, the vulnerable object detection algorithm 36 may receive inputs from the vehicle 10, including a gear position and/or vehicle speed, such that the vulnerable object detection algorithm 36 is not unintentionally activated out of specific use cases (e.g., the vulnerable detection algorithm is operated when the vehicle is parked and not moving).

Based on the object detection results, the headlamp control algorithm may determine whether the headlamps 22 of the vehicle 10 should be turned on. For example, responsive to determining that a vulnerable object is present, the headlamps 22 may not be turned on, and an alert or warning may be generated to the driver of the vehicle 10. The alert may include a visual message (e.g., an icon illuminated at the gauge cluster of the vehicle and/or a message displayed at a display screen of the vehicle) and/or an audio alert (e.g., a tone or audio message played via an audio system of the vehicle) indicating that the vulnerable object has been detected and operation of the headlamps 22 has been at least partially adjusted or deactivated. Optionally, operation of the headlamps 22 may remain adjusted or off or deactivated until the vulnerable object moves out of the field of illumination of the headlamps 22 (away from the front of the vehicle), until the driver provides an input overriding the system 12 (e.g., via an input in the cabin of the vehicle to turn on the headlamps 22), and/or until the vehicle is shifted into a forward or reverse driving gear and/or begins moving.

Optionally, responsive to determination of the vulnerable object, the headlamps 22 may be operated at a reduced brightness. That is, the headlamps may be operated to emit light at a brightness or intensity that is less than the operating brightness or intensity when no vulnerable object is present. In some examples, responsive to determination of the vulnerable object, the headlamps 22 may be operated at reduced brightness and then gradually increased to full brightness to give the vulnerable object time to adjust to the brightness, look away from the headlamps 22, or move out of the field of illumination.

In some examples, the system may adjust operation of the headlamps 22 to emit light and illuminate the environment in front of the vehicle while avoiding emitting light directed toward the detected vulnerable object. For example, in response to determining presence of the detected vulnerable object in the illumination field of one headlamp or set of headlamps, like the driver side headlamp, but not in the illumination field of the other headlamp or set of headlamps, like the passenger side headlamp, the system may deactivate or reduce brightness of the one headlamp (i.e., the driver side headlamp) while maintaining operation of the other headlamp (i.e., the passenger side headlamp). Optionally, the system may adjust operation of the headlamps (e.g., deactivate or reduce brightness of individual light sources of the headlamp) to reduce brightness or deactivate portions of the field of illumination where the detected object is present.

The vision system 12 may monitor the region forward of the vehicle 10 to detect vulnerable objects and determine whether the headlamps 22 may be operated in response to a vehicle condition. For example, determination of whether to operate the headlamps 22 may occur upon vehicle startup (e.g., when a propulsion system or ignition of the vehicle is turned on) and/or in response to a driver input turning on the headlamps 22. In some examples, the headlamps 22 may be operated automatically, such as based on an ambient light level of the vehicle 10, and the system 12 may determine whether to operate the headlamps in response to a signal from the automatic headlamp system of the vehicle 10 indicating that the headlamps should be turned on due to low ambient light levels at the vehicle 10. The system 12 may only determine whether or not to operate the headlamps 22 when the vehicle is parked or stopped (e.g., a propulsion system or transmission of the vehicle is in a park gear and the vehicle is not moving). In other words, the system 12 may operate only when the vehicle 10 is in park and at startup or shutdown. This ensures that the system 12 does not interfere with normal driving conditions when the vehicle comes to a stop. The system 12 may process the captured sensor data for determining presence of the vulnerable object upon vehicle startup to avoid significant delays in activating the headlamps 22 when the vulnerable object is not detected.

Thus, the system 12 may address a significant safety concern by proposing an innovative solution to control vehicle headlamps 22 based on the presence of individuals, particularly small children, in front of the vehicle 10. By integrating multiple sensors and employing advanced algorithms for object detection and classification, the system may ensure that the headlamps 22 are activated conditionally, thereby preventing potential harm. The system may be designed to be effective in specific scenarios, primarily when the car is in park mode and at startup or shutdown, ensuring that the system does not disrupt normal driving operations. This approach not only enhances safety but also contributes to the overall well-being of individuals in proximity to the vehicle 10.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. No. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Optionally, the camera may comprise a forward viewing camera, such as disposed at a windshield electronics module (WEM) or the like. The forward viewing camera may utilize aspects of the systems described in U.S. Pat. Nos. 12,174,448; 11,635,672; 11,124,130; 9,896,039; 9,871,971; 9,596,387; 9,487,159; 8,256,821; 7,480,149; 6,824,281 and/or 6,690,268, which are all hereby incorporated herein by reference in their entireties.

The camera module and circuit chip or board and imaging sensor may be implemented and operated in connection with various vehicular vision-based systems, and/or may be operable utilizing the principles of such other vehicular systems, such as a vehicle headlamp control system, such as the type disclosed in U.S. Pat. Nos. 5,796,094; 6,097,023; 6,320,176; 6,559,435; 6,831,261; 7,004,606; 7,339,149 and/or 7,526,103, which are all hereby incorporated herein by reference in their entireties.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

The radar sensor or sensors may be disposed at the vehicle so as to sense exterior of the vehicle. For example, the radar sensor may comprise a front sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with a surround vision system of the vehicle, or the radar sensor may comprise a blind spot monitoring radars disposed at a rear fender of the vehicle for monitoring sideward / rearward of the vehicle for a blind spot monitoring and alert system of the vehicle. Optionally, the radar sensor or sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular sensing system, the vehicular sensing system comprising:
a camera disposed at a vehicle equipped with the vehicular sensing system, wherein the camera views exterior of the vehicle and at least forward of the vehicle, and wherein the camera is operable to capture image data;
wherein the camera comprises an imager, and wherein the imager comprises a CMOS imaging array having at least one million photosensors arranged in rows and columns;
an electronic control unit (ECU);
wherein the ECU comprises electronic circuitry and associated software;
wherein the electronic circuitry of the ECU comprises an image processor for processing image data captured by the camera and transferred to the ECU;
wherein the vehicular sensing system, at least in part via processing at the ECU of image data captured by the camera and transferred to the ECU, (i) detects an object that is present exterior of the vehicle and at or near a field of illumination of a headlamp of the vehicle and (ii) determines that the object comprises a vulnerable object that should not be present in the field of illumination of the headlamp of the vehicle when the headlamp is electrically operated to emit light; and
wherein, with the vehicle parked, and responsive to determination of the vulnerable object present exterior of the vehicle and at or near the field of illumination of the headlamp of the vehicle, the vehicular sensing system controls operation of the headlamp of the vehicle to limit the headlamp from electrically operating to emit light.

2. The vehicular sensing system of claim 1, wherein the vehicular sensing system controls operation of the headlamp of the vehicle to prevent the headlamp from electrically operating to emit light.

3. The vehicular sensing system of claim 1, wherein the vehicular sensing system controls operation of the headlamp of the vehicle to reduce an intensity of light emitted by the headlamp when electrically operating to emit light.

4. The vehicular sensing system of claim 1, wherein the vehicular sensing system performs object classification to determine that the object comprises the vulnerable object.

5. The vehicular sensing system of claim 1, wherein the vulnerable object comprises a human.

6. The vehicular sensing system of claim 1, wherein the vulnerable object comprises a child.

7. The vehicular sensing system of claim 1, wherein the vulnerable object comprises an animal.

8. The vehicular sensing system of claim 1, wherein the vehicular sensing system determines that the object comprises the vulnerable object based on determination that the object is moving toward the field of illumination.

9. The vehicular sensing system of claim 1, wherein the camera is disposed at an in-cabin surface of a windshield of the vehicle, and wherein the camera views through the windshield to view exterior of the vehicle and at least forward of the vehicle.

10. The vehicular sensing system of claim 1, wherein the camera is disposed at an exterior portion of the vehicle.

11. The vehicular sensing system of claim 1, wherein the vehicular sensing system detects the object and determines that the object comprises the vulnerable object at least in part via processing sensor data captured by an ultrasonic sensor disposed at the vehicle.

12. The vehicular sensing system of claim 1, wherein the vehicular sensing system detects the object and determines that the object comprises the vulnerable object at least in part via processing sensor data captured by a radar sensor disposed at the vehicle.

13. The vehicular sensing system of claim 1, wherein the vehicular sensing system detects the object and determines that the object comprises the vulnerable object at least in part via processing sensor data captured by a near infrared camera disposed at the vehicle.

14. A vehicular sensing system, the vehicular sensing system comprising:
a camera disposed at a vehicle equipped with the vehicular sensing system, wherein the camera views exterior of the vehicle and at least forward of the vehicle, and wherein the camera is operable to capture image data;
wherein the camera comprises an imager, and wherein the imager comprises a CMOS imaging array having at least one million photosensors arranged in rows and columns;
a sensor disposed at the vehicle, wherein the sensor senses exterior of the vehicle and at least forward of the vehicle, and wherein the sensor is operable to capture sensor data;
an electronic control unit (ECU);
wherein the ECU comprises electronic circuitry and associated software;
wherein the electronic circuitry of the ECU comprises at least (i) an image processor for processing image data captured by the camera and transferred to the ECU and (ii) a data processor for processing sensor data captured by the camera and transferred to the ECU;
wherein the vehicular sensing system, at least in part via processing at the ECU of sensor data captured by the sensor and transferred to the ECU, detects an object that is present exterior of the vehicle and at or near a field of illumination of a headlamp of the vehicle;
wherein the vehicular sensing system performs object classification to determine that the detected object comprises a vulnerable object that should not be present in the field of illumination of the headlamp of the vehicle when the headlamp is electrically operated to emit light based at least in part via processing at the ECU of at least one selected from the group consisting of (i) sensor data captured by the sensor and transferred to the ECU and (ii) image data captured by the camera and transferred to the ECU; and
wherein, with the vehicle parked, and responsive to determination of the vulnerable object present exterior of the vehicle and at or near the field of illumination of the headlamp of the vehicle, the vehicular sensing system controls operation of the headlamp of the vehicle to limit the headlamp from electrically operating to emit light.

15. The vehicular sensing system of claim 14, wherein the vehicular sensing system controls operation of the headlamp of the vehicle to prevent the headlamp from electrically operating to emit light.

16. The vehicular sensing system of claim 14, wherein the vehicular sensing system controls operation of the headlamp of the vehicle to reduce an intensity of light emitted by the headlamp when electrically operating to emit light.

17. The vehicular sensing system of claim 14, wherein the vehicular sensing system performs object classification based at least in part via processing at the ECU of image data captured by the camera and transferred to the ECU, and wherein the sensor comprises one selected from the group consisting of (i) an ultrasonic sensor and (ii) a radar sensor.

18. The vehicular sensing system of claim 14, wherein the sensor comprises a near infrared camera, and wherein the vehicular sensing system performs object classification based at least in part via processing at the ECU of sensor data captured by the near infrared camera and transferred to the ECU.

19. A vehicular sensing system, the vehicular sensing system comprising:
a camera disposed at a vehicle equipped with the vehicular sensing system, wherein the camera views exterior of the vehicle and at least forward of the vehicle, and wherein the camera is operable to capture image data;
wherein the camera comprises an imager, and wherein the imager comprises a CMOS imaging array having at least one million photosensors arranged in rows and columns;
wherein the camera is disposed at an in-cabin surface of a windshield of the vehicle, and wherein the camera views through the windshield to view exterior of the vehicle and at least forward of the vehicle;
a sensor disposed at the vehicle, wherein the sensor senses exterior of the vehicle and at least forward of the vehicle, and wherein the sensor is operable to capture sensor data;
wherein the sensor comprises at least one selected from the group consisting of (i) an ultrasonic sensor and (ii) a radar sensor;
an electronic control unit (ECU);
wherein the ECU comprises electronic circuitry and associated software;
wherein the electronic circuitry of the ECU comprises at least (i) an image processor for processing image data captured by the camera and transferred to the ECU and (ii) a data processor for processing sensor data captured by the camera and transferred to the ECU;
wherein the vehicular sensing system, at least in part via processing at the ECU of sensor data captured by the sensor and transferred to the ECU, detects an object that is present exterior of the vehicle and at or near a field of illumination of a headlamp of the vehicle;
wherein the vehicular sensing system, at least in part via processing at the ECU of image data captured by the camera and transferred to the ECU, determines that the object comprises a vulnerable object that should not be present in the field of illumination of the headlamp of the vehicle when the headlamp is electrically operated to emit light; and
wherein, with the vehicle parked, and responsive to determination of the vulnerable object present exterior of the vehicle and at or near the field of illumination of the headlamp of the vehicle, the vehicular sensing system controls operation of the headlamp of the vehicle to limit the headlamp from electrically operating to emit light.

20. The vehicular sensing system of claim 19, wherein the vehicular sensing system controls operation of the headlamp of the vehicle to reduce an intensity of light emitted by the headlamp when electrically operating to emit light.
